(19) United States
(12) Patent Application Publication
(10) Pub. No.: US 2007/0236813 A1
(43) Pub. Date: Oct. 11, 2007

(54) MAGNIFYING APPARATUS

(76) Inventors: Robert Gary Josephberg, Briarcliff Manor, NY (US); Ian Robert Blum, New Rochelle, NY (US)

Correspondence Address: Ian Blum, 20 Stanton Cir, New Rochelle, NY, 10804, US

(21) Appl. No.: 11/697,211

(22) Filed: Apr. 5, 2007

Related U.S. Application Data
(60) Provisional application No. 60/789,479, filed on Apr. 5, 2006.

(51) Int. Cl. G02B 27/02

(52) U.S. Cl. 359/802

(57) ABSTRACT

A magnifying apparatus removably attached to a menu, check wallet, billfold, wine list, and the like. The magnifying apparatus includes illumination means to illuminate an area viewed using the magnifying apparatus. The magnifying element may be a fresnel lens. The fresnel lens preferably has a power of 2-4 times. However, a magnification of up to 9 times or more can be used. The magnifying element may also be a standard lens preferably having a high index of refraction. It is preferable to have a high index of refraction to minimize the thickness of the lens. The standard lens or the fresnel lens is plastic, glass, polycarbon, or the like. Electronic magnification and display means may also be used.

### CROSS-REFERENCE TO RELATED APPLICATIONS

This application claims priority from application Ser. No. 60/789,479, filed Apr. 5, 2006, the entirety of which is incorporated herein by reference.

### FIELD OF THE INVENTION

The present invention relates to magnifiers and is more specifically directed to an illuminating magnifying apparatus for use in restaurants.

### PRIOR ART

As is well known in the restaurant industry, eating establishments range in quality from elegant 5-star restaurants to bistros nothing more than greasy spoons, the one serving continental delicacies and the other serving what almost amounts to blue-plate specials. While service in the more-expensive establishment may be romantic, by candlelight, the service in the others may be garish, under fluorescent lighting. On the other hand—and as will be appreciated by anyone who has had the occasion to visit both types of places—the very bright illumination which interferes with the quiet of an interlude, at the same time makes it far easier to read a menu, or wine list—whose content, many times, is written in words less pronounceable and understandable than roast chicken, fried shrimp or chopped steak. In actuality, the candle lit atmosphere of the high-end restaurant frequently makes a reading of a wine list, a menu or the presented bill at the end of the meal difficult at best, and almost impossible at worst.

There have long been reading lenses and magnifying glasses available to assist people in reading books, documents and the like without the use of reading glasses. These are particularly useful when the person encounters small print during an activity which makes it inconvenient or difficult to stop and put on reading glasses.

As an example, a book mark such as that shown in U.S. Pat. No. 3,140,883 issued to R. L. Anthony on Jul. 14, 1964, may be integrally attached to a book such as a telephone directory or a dictionary, wherein the end of the book mark is provided with a sealed pocket for receiving a plastic magnifying lens. The magnifying lens may be moved up and down the page as desired to provide magnification of the text in the book permitting the user to read the text without first putting on his eyeglasses.

A pocket magnifier such as that shown in U.S. Pat. No. 3,409,347 issued to R. Vogel on Nov. 5, 1968, includes a pocket pouch adapted to be carried in the breast or hip pocket of the user or in a purse or wallet. The lens is formed of a transparent plastic sheet material having a substantial degree of stiffness and having fresnel lens contours molded into its upper surface. The lens unit may be slidably retracted into and extended out of the pocket. The pocket magnifier may be easily utilized to magnify small print and the like when the user is in a location where it is not feasible or desirable to stop an activity in order to put on reading glasses.

Other examples of special purposes magnifying lens structures are shown, by way of example, in U.S. Pat. No. 4,044,889 entitled “Cosmetic Container Including Integrated Lens Structure,” issued to S. Orentreich et al. on Aug. 30, 1977, and U.S. Pat. No. 4,393,610 entitled “Card Carrying Microfilm and Associated Reading Lens and Process of Forming Same,” issued to D. Adrian on Jul. 19, 1983.

With the ever expanding use of credit cards and other transaction cards, there is an increasing requirement that the card user be able to verify a transaction at the point-of-use. This means the user must be able to read the card invoice to determine the accuracy of the information before he signs the invoice to indicate his acceptance. Since most of the information on the invoice is impact printed either on a carbon set or carbonless form, the print is not only controlled in size but is often of a low contrast with respect to the base form paper. This makes the form difficult to read, particularly for those who normally require reading glasses. Also, when the transaction card is used, it is often not convenient to take the time to put on reading glasses before reviewing the card invoice. While the pocket magnifiers of the prior art could be used for this purpose, use of such devices requires a separate activity which does not provide a great improvement over the use of reading glasses. As a result, many credit card users simply do not take the time and effort to accurately verify a transaction at the point-of-sale, relying on the sales clerk for the accuracy of the information. A transaction card incorporating a magnifying lens has been proposed in Japanese Utility Model Application Kokai No. 2-56680 published Apr. 24, 1990. Other credit cards with magnifiers have been proposed, some including a light. However, users may be embarrassed to use a card with a magnifying area and light. What is needed is a magnifying apparatus to overcome the problems present in the prior art.

### SUMMARY OF THE INVENTION

The present invention provides a magnifying apparatus preferably removably attached to a menu, check wallet, billfold, wine list, and the like. In a preferred embodiment, the magnifying apparatus includes illumination means to illuminate an area viewed using the magnifying apparatus.

In a preferred embodiment, the magnifying element is a fresnel lens. The fresnel lens preferably has a power of 2-4 times. However, a magnification of up to 9 times or more can be used. In another embodiment, the magnifying element is a standard lens preferably having a high index of refraction. It is preferable to have a high index of refraction to minimize the thickness of the lens. The standard lens or the fresnel lens is plastic, glass, polycarbon, or the like. It should be noted that the magnifying element is preferably approximately 6 inches (approximately 15.24 centimeters) from the surface to be magnified.

In yet another embodiment, the magnifying element includes a clear LCD screen and CCD camera. When not activated, the LCD screen is preferably clear so a user can see through the LCD screen to the area below the screen. Once the magnifying device is activated, the CCD or other capture device captures an image of the item to be magnified and displays the magnified image on the now opaque LCD screen.

Illumination for the device is provided via LEDs, incandescent bulbs, fiber optics, or the like. The illumination is directed towards the item to be magnified from the support for the magnifying element or from the frame supporting the magnifying element.

### BRIEF DESCRIPTION OF THE DRAWINGS

FIG. 1 is a perspective view of the invention in a check presenter;

FIG. 2 is a side view of a first embodiment of the invention;

FIG. 3 is a side view of a second embodiment of the invention;

FIG. 4 is a side view of a third embodiment of the invention;

FIG. 5 is a side view of a fourth embodiment of the invention;

FIG. 6 is a side view of a fifth embodiment of the invention; and

FIG. 7 is a side view of a sixth embodiment of the invention.

### DETAILED DESCRIPTION OF THE PREFERRED EMBODIMENT

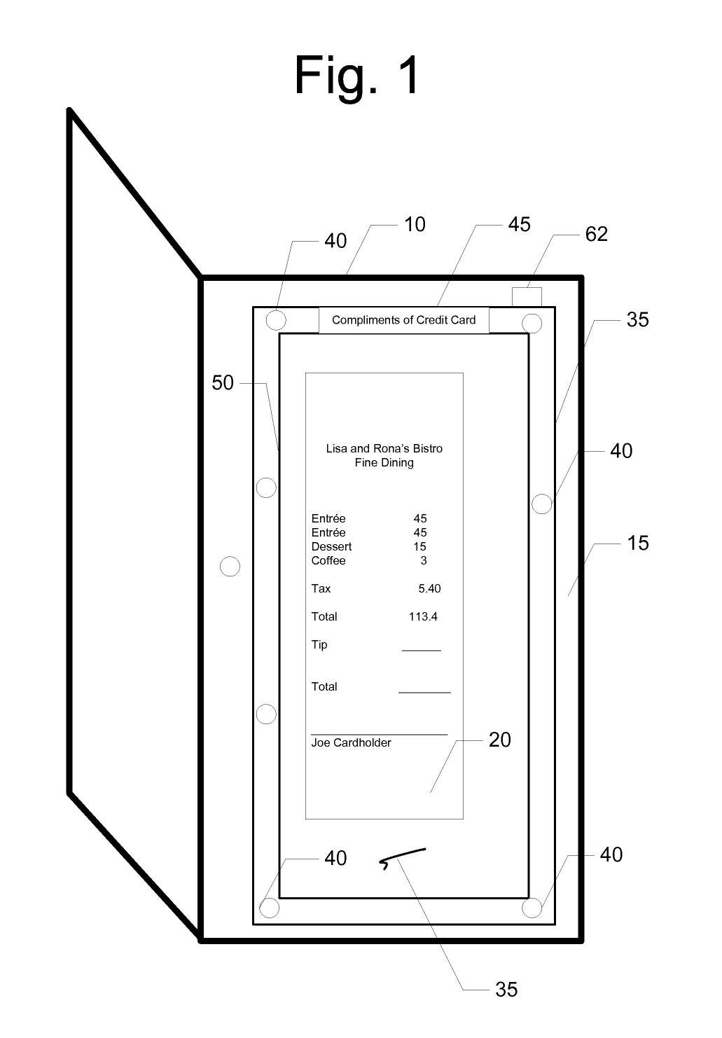

FIG. 1 depicts a standard check presenter. However, it should be noted that the disclosed device is applicable to tip trays, menus, wine lists, brochures, pamphlets, books, and the like. As shown, a standard check presenter 10 includes portion 15 to secure a bill 20 or guest check 20. Additionally, the check presenter 10 includes a magnifying element 35 held in a frame 30 supported by at least one extending arm 50 (not shown in this view). The arms 50 are preferably removably attached to the check presenter 10. In another embodiment, the supporting arms 50 are permanently affixed to the check presenter 10. It should be note that the magnifying element 35 need not include a frame 30. In this embodiment, the supporting arms 50 are affixed to the lens 35. Additionally, the arms 50 can be affixed to the check presenter 10 via a support mount. The magnifying assembly is affixed to the check presenter 10 using attaching means such as screws, rivets, Velcro®, tape, double sided tape, epoxy, glue, stitching, clips, and the like. In one embodiment, the magnifying assembly 30/35 includes an area 45 for advertising. The area 45 can be on the top, side, or bottom of the assembly 30/35. In one embodiment, magnifying element 35 is held down when not in use or not needed using securing means 62. In a preferred embodiment, securing means orient the bill 20 so that it is positioned for magnification. It should be noted that the patron can sign the bill 20 or credit card receipt 20 without removing it from the check presenter 10.

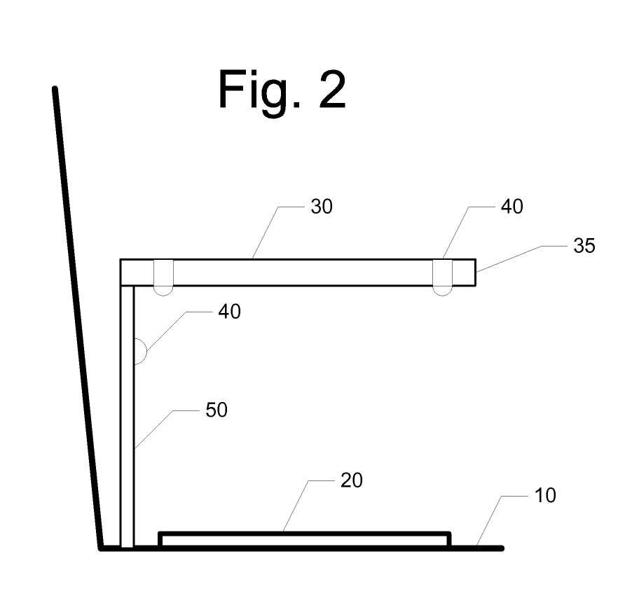

In one embodiment, the magnifying apparatus includes at least one illuminating element 40. The illuminating element 40 can be one or more LEDs, incandescent bulbs, fiber optic elements, and the like. The illuminating elements 40 are part of the frame 30, the magnifying means 35, or the support members 50. As shown in FIG. 2, the illuminating elements 40 can be part of the frame 30 or magnifying element 35 or affixed to the support structure 50. It should be noted that the illuminating means can be affixed to any of the supporting means discussed herein or integrated into the magnifying means or the frame for the magnifying means.

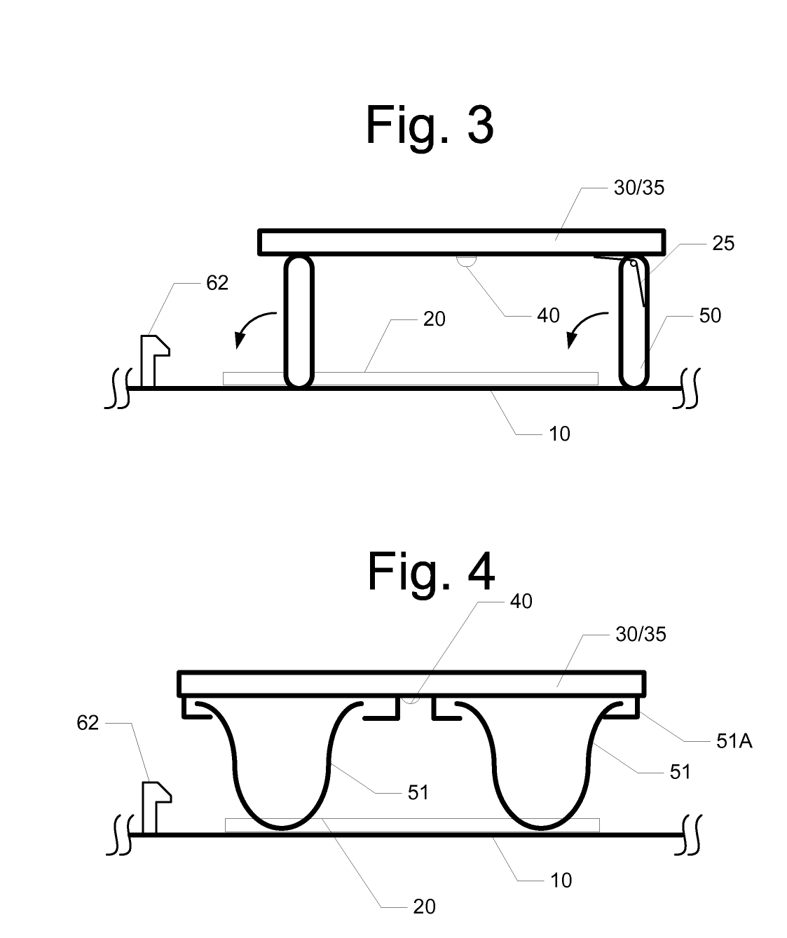

FIG. 3 depicts a side view of the check presenter 10 and magnifying structure. As shown, the structures 50 are rotatably attached to the check presenter 10 such that the magnifying element 35 and frame 30 can be folded substantially flush with the check presenter 10. The support arms 50 are pivotably connected to the check presenter 10 and the frame 30 or magnifying element 35. The connection means are axles, hinges, slides, or the like. In a preferred embodiment, the magnifying structure is spring loaded with a spring 25 that raises the magnifying element 35. It should be noted that the spring 25 is shown attached between the support structure 50 and the lens frame assembly 30/35. In another embodiment, the spring 25 is placed between the check presenter 10 and the support structure 50. In yet another embodiment, a frame is used to affix the support structures 50 to the check presenter 10. The spring can be affixed between the support structure and the means used to affix the structure to the check presenter 10. Spring 25 is a coil spring, leaf spring, or other resilient material.

FIG. 4 depicts another embodiment of the magnifying apparatus. As shown, a spring element 51 is connected to the check presenter 10 and is movable attached to the magnifying element/frame 30/35. The spring 51 and attaching means 51A are configured such that the magnifying element can be substantially flattened to the check presenter 10. In the alternative, spring element 51 is connected to the frame 30 and or lens 35 and is moveably connected to the check presenter 10. It should be understood that the spring 51 is able to compress to a substantially flat position and that attaching means 51A can accommodate the spring 51. In an alternative embodiment, the spring 51 travels in a slot in either the lens, the lens holder, or the billfold, menu, or the like.

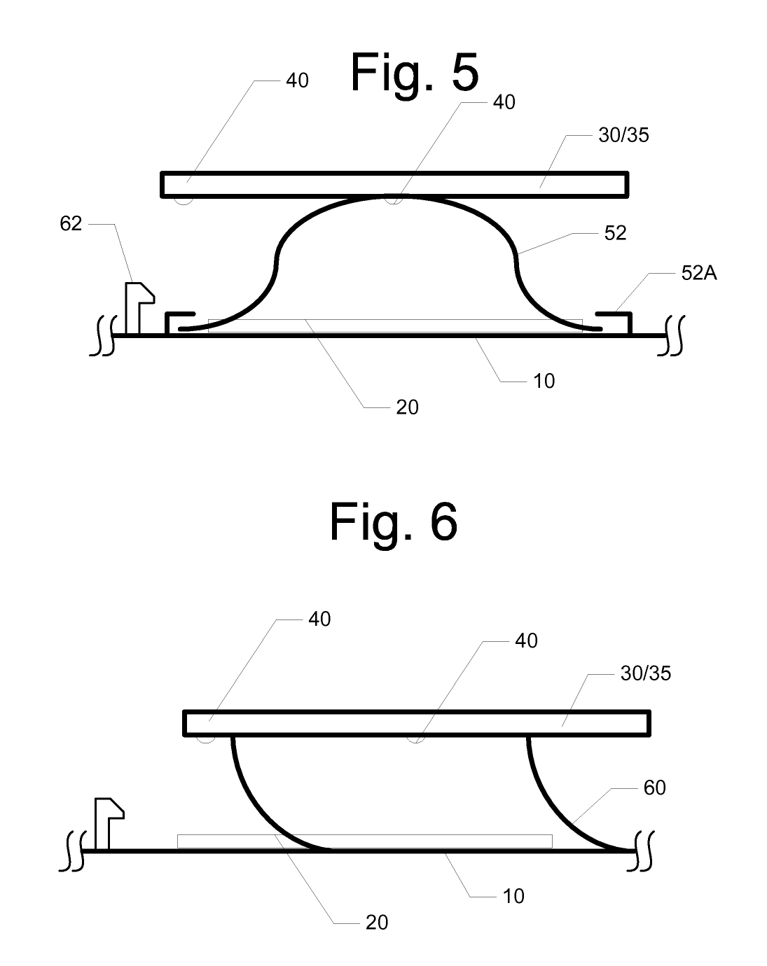

As shown in FIG. 5, the magnifying element 30/35 is affixed to a spring 52. The spring 52 is movably attached to the check presenter 10 with attaching means 52A. The spring 52 and attaching means 52A are configured such that when the check presenter 10 is closed, the magnifying element 30/35 is substantially touching the check presenter 10. Alternatively, the magnifying element 30/35 is moveably connected to a spring 52 and the spring 52 is affixed to the check presenter 10. It should be understood that the spring 52 is able to compress to a substantially flat position and that attaching means 52A can accommodate the spring 52. In an alternative embodiment, the spring 52 travels in a slot in either the lens, the lens holder, or the billfold, menu, or the like. The position of at least one illuminating element 40 is on the lens and frame 30/35 the support, or the like. In one embodiment, the lens 35 does not require a frame 30.

As shown in FIG. 6, a spring 60 is affixed to both the check presenter 10 and the magnifying element 30/35. Again, the spring 60 is configured such that when the check presenter 10 is closed, the magnifying element is flattened, the spring is flattened so that the magnifying element 30/35 is substantially touching the check presenter 10.

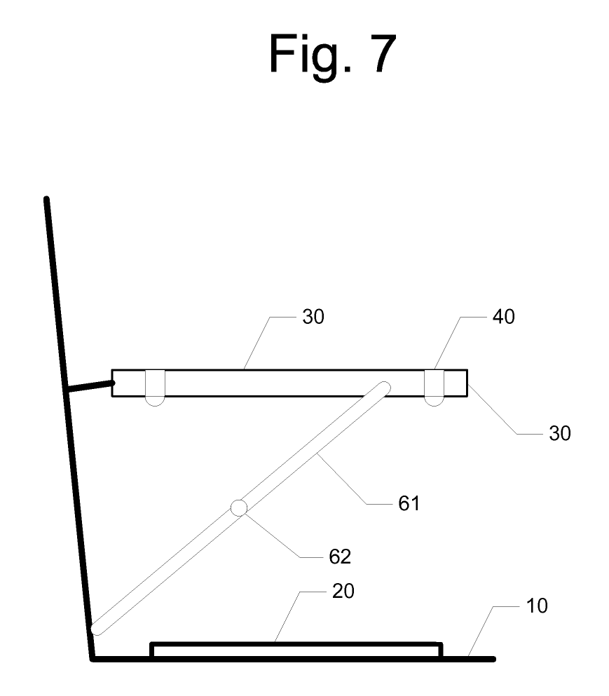

As shown in FIG. 7, the lens, and in one embodiment the lens frame assembly, is affixed to the cover of the billfold. Support arm 61 is moveably attached to the lens and or frame if used. Further, support arm 61 is moveably attached to the billfold, either the cover or the base. Support arm 61 has a joint, bending means, 62 that allows the support arm 61 to fold when the billfold is closed.

While various attaching means have been disclosed, other attaching means can be used. Additionally, for tip trays, and other flat items or trays having a lip or raised edge without a closing cover, opening and closing means can be included. For example, a latch 62, shown in FIG. 6, holds the magnifying means 30/35 down until latch 62 is activated, thereby releasing the magnifying element to be in its use position.

Additionally, it should be noted that in any of the above embodiments, the lighting elements 40 can be included to illuminate the object to be magnified. In one embodiment, for menus, wine lists, brochures, and the like, the magnifying element can be rotated about the center of the brochure, wine list, menu, or the like, so that either side will be magnified. In this embodiment, the side of the publication being magnified is illuminated. In another embodiment, the magnifying element is able to slide across the top or bottom of the printed publication so that either side of the printed publication can be illuminated. In another embodiment, the magnifying element is attached to the check presenter 10 using telescoping arms 50.

The illuminating means are preferably activated when needed. In other words, when the check wallet is opened the LEDs, bulbs, or the like are activated. The activation can be accomplished via a contact switch, a mercury switch, a magnetic switch, a photosensitive switch, or the like. In one embodiment, the support structure also creates the circuit for the illumination components. In one embodiment, the illuminating device is turned off after a set time period or if no movement is detected for a predetermined time.

Lens 35 is preferably a fresnel lens. In a preferred embodiment, the lens is substantially 6 inches (15.24 centimeters) from the surface of the check presenter 10. However, the lens can be higher or lower depending on design requirements, magnification, and the like. In a preferred embodiment, the fresnel lens has a power of 2 to 4. However, a fresnel lens having a power of 9 or more can be used. Alternatively, a lens can be used. In a preferred embodiment, the lens would have a high index of refraction minimizing the thickness of the lens. The magnifying element (the lens or fresnel lens) can be plastic, glass, polycarbonate, other clear material, or the like. In one embodiment, the lens can be filled with liquids of different indexes of refraction to modify the magnification. In a preferred embodiment, the fresnel lens is 1 to 4 inches (2.54 to 10.16 centimeters) from the surface.

The mounting element can be along the top, bottom, side, or center fold of the billfold, menu, or the like.

In another embodiment, the magnifying element includes a clear LCD screen and a CCD element that can capture the entire document placed under the magnification device. When the device is activated, the LCD screen becomes opaque and displays a magnified image of the item to be magnified. A timing device will preferably turn off the display after a set time or if no movement is detected.

Those skilled in the art can now appreciate from the foregoing description that the broad teachings of the present invention can be implemented in a variety of forms. Therefore, while this invention has been described in connection with particular examples, thereof, the true scope of the invention should not be so limited since other modifications will become apparent to the skilled practitioner upon a study of the drawings, the specification, and the following claims.

1. A check presenter comprising:
a first area adapted to hold a bill;
a support attached to the check presenter;
a magnifier connected to the support means adapted to magnify the first area; and
illumination means affixed to the magnification means adapted to illuminate the first area.

2. The check presenter of claim 1, wherein the illumination means is at least one light emitting diode.

3. The check presenter according to claim 1, wherein the magnifier is a fresnel lens.

4. The check presenter according to claim 1, wherein the magnifier is a standard lens.

5. The check presenter according to claim 4, wherein the standard lens has a high index of refraction.

6. The check presenter according to claim 1, further comprising:
a camera adapted to capture the bill presentation area; and
wherein the magnifier is a display adapted to display the image captured by the camera.

7. The check presenter according to claim 1, wherein the support is affixed to the check presenter by attaching means selected from the group consisting of screws, rivets, tape, glue, and stitching.

8. The check presenter according to claim 1, wherein the support is a hinged lever arm.

9. The check presenter according to claim 1, wherein the support further comprises at least one spring.

10. The check presenter according to claim 1, wherein the support is removeably attached to the check presenter.

11. The check presenter according to claim 1, further comprising switch means adapted to activate the illumination means.

12. The check presenter according to claim 11, further comprising:
a cover moveably connected to the first area, wherein the switch means is activated when the cover is moved away from the first area.

13. The check presenter according to claim 1 wherein the support is a spring.

14. The check presenter according to claim 1 further comprising retentions means located in the first area adapted to hold the bill.
